(19) United States
(12) Patent Application Publication
(10) Pub. No.: US 2005/0170922 A1
(43) Pub. Date: Aug. 4, 2005

(54) Tensioner having a tensioning pressure control valve

(76) Inventor: Wolfram Hellmich, Munchen (DE)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/505,102

(22) PCT Filed: Oct. 31, 2002
(86) PCT No.: PCT/EP02/12217

(30) Foreign Application Priority Data
Feb. 20, 2002 (DE) 202 02 664.7

(51) Int. Cl. F16H 7/08; F16H 7/22

(52) U.S. Cl. 474/110

(57) ABSTRACT

A tensioner for endless transmission elements such as chains or belts, having a pressure compartment that is impinged upon a tensioning pressure to actuate tensioning means acting upon the transmission element, a supply connection that is impinged upon by a supply pressure, and a valve interposed between the pressure compartment and the supply connection and comprising a closing unit that can be transferred to closed position by the tensioning pressure. The valve is designed as a tensioning pressure control valve, and the closing unit is provided with a substantially spring-elastic pretensioning element that counteracts the transfer to the closed position.

The invention relates to a tensioner for endless transmission elements, such as chains or belts, comprising a pressure chamber, that is pressurised by a tensioning pressure to actuate tensioning means acting upon the transmission element, a supply connection that is pressurised by a supply pressure, and a valve interposed between the pressure chamber and the supply connection and comprising a closing unit that can be transferred to a closed position by the tensioning pressure.

Tensioners of this type are for instance used for tensioning chains, such as control chains of internal combustion engines. The supply connection of the tensioner is usually connected to the oil circuit of the internal combustion engine. It is problematic that the oil circuit is designed in consideration of other criteria and not for the operation of the tensioner. This results in the fact that in the case of high fluctuations of the supply pressure beyond the operating duration of the engine, particular in the case of pressure peaks of the supply pressure, the tensioning pressure unnecessarily rises. An excessive tensioning pressure, however, leads to an increase in wear and to increased frictional forces in the endless transmission elements.

To avoid excessive tensioning pressures, tensioners are known in the prior art, in which a pressure control valve is provided in the pressure chamber in addition to the valve between the supply connection and the pressure chamber. Tensioners of this type are known from U.S. Pat. No. 6,193,623 B1 and DE 41 33 560 A1.

In a development of the pressure chamber secured by a pressure control valve, the pressure control valves are combined with a return valve arranged between the supply connection and the pressure chamber in a complex component. Tensioners of this type are described and shown in EP 0 686 787 B1 and DE 38 24 555 C1.

The solutions described in the prior art for avoiding an excessive tensioning pressure are all very complex and reveal a large number of pieces and are therefore difficult to assemble.

Thus, it is the object of the invention to provide a simply designed tensioner in which excessive tensioning pressures occurring during operation are avoided.

This object is solved according to the invention for a tensioner of the above-mentioned kind in that the valve is formed as a tensioning pressure control valve, in that the closing means comprises a substantially spring-elastic pretensioning element counteracting the transfer into the closing position.

This solution is structurally simplified compared to the prior art, since the valve between the supply connection and the pressure chamber being a tensioning pressure control valve automatically keeps the tensioning pressure on a predetermined level. This level is substantially determined by a pretensioning force generated by the spring-elastic pretensioning element, which counteracts the effect of the tensioning pressure and which transfers the closing means into the open position. Due to the design as a control valve, the use of pressure control valves in the pressure chamber can substantially be renounced. Excessive tensioning pressures can no longer be produced in the embodiment of the tensioner according to the invention.

A further advantage of the solution according to the invention in the use in internal combustion engines is to be seen in that if the combustion engine is turned off, the valve is transferred from the closed position into the open position by means of the pretensioning element. This ensures that the pressure chamber when starting the engine can immediately be filled by a pressure fluid.

The closing means of the valve may comprise a closing body according to an advantageous embodiment, through which in the closing position a connection line between the supply connection and the pressure chamber is locked in a pressure-tight manner. The closing body may for instance be shaped substantially spherical, and may sealingly cooperate with a respective valve seat in the closing position. A needle-shaped design of the closing body is also possible in an alternative embodiment.

Furthermore, the valve between the supply connection and the pressure chamber may be formed as a return valve.

According to an especially preferred embodiment of the tensioner, the closing unit may comprise an operating element, by means of which the closing unit is pressed into the closing position when exceeding a predetermined tensioning pressure. By means of this additional operating element structurally separated from the closing body, a more precise transfer of the closing unit into the closing position may be achieved. For this purpose, the pretensioning element may according to a development of the invention be supported between a housing-sided section of the tensioner on the one hand and the operating means on the other hand.

In order to achieve a quick transfer into the open position and in order to design the structure in a possibly simple way, the operating element and the closing body may be accommodated in the tensioner in a manner substantially independent of each other. In this embodiment, the closing body is restricted in its freedom of movement by the operating element only when transferred into the closing position and it is pressed into the closing position. In the open position, the closing body is freely movable so that independent of the operating element in the case of other conditions, the closing position can be taken by the closing body.

In order to precisely control the tensioning pressure, the operating element may have a pressure receiving surface adjoining the pressure chamber. The tensioning pressure acts on this pressure receiving surface which counteracts the pretensioning force generated by the pretensioning element. The ratio of pretensioning force and closing force determines the tensioning pressure that transfers the closing means into the closing position.

In order to move the closing body into the closing position, an end of the operating element may reach up to the closing body. This end preferably opposes the end of the operating element which is provided with the pressure receiving surface.

A simple constructive embodiment of the closing unit results when the operating element is formed as a piston longitudinally movable substantially in the tensioning direction of the tensioner. The piston may be formed cylindrically so that it is easy to manufacture.

In order to obtain a possibly small tensioner, the helical springs and the operating means may be at least sectionally arranged in a coaxially overlapping manner.

Furthermore, the operating element may be arranged in an aperture extending substantially in parallel to a connection line between the valve and the pressure chamber.

The tensioner may selectively comprise a pressure chamber substantially sealed towards the outside, or it may comprise a leakage means through which the tensioning pressure in the pressure chamber is gradually decreased during operation. This embodiment is particularly sensible when being used in internal combustion engines: If the internal combustion engine is switched off and if supply pressure is not applied at the supply connection, the tensioning pressure gradually decreases by leakage through the leakage means. In the embodiment according to the invention, the closing unit is pressed into the open position depending on the pretensioning force of the pretensioning element. If the internal combustion engine is started, the connection between the connection terminal and the pressure chamber is open during the start, the pressure chamber may be quickly filled and the tensioning pressure can quickly be reduced.

The leakage line may lead from the pressure chamber to the outer environment of the tensioner. The possibly high flow resistance in the leakage line, for instance by a small flow cross section, ensures that an only gradual reduction of the tensioning pressure may take place in the pressure chamber.

The structure and the function of the tensioner will now be described by means of an embodiment with reference to the attached drawings.

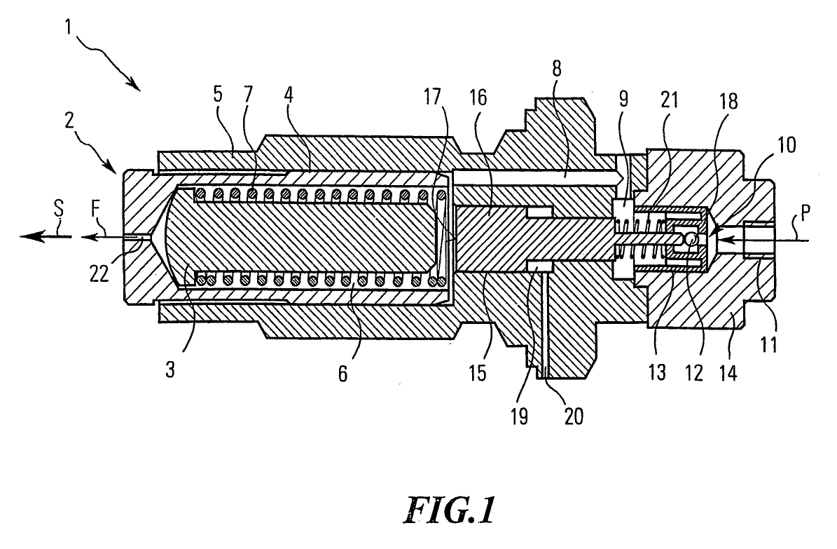

FIG. 1 shows the back of a longitudinal section through an embodiment of the tensioner according to the invention.

FIG. 1 shows a tensioner 1 with a tensioning means 2 for tensioning endless transmission elements (not shown). The tensioner 1 shown in FIG. 1 is particularly suitable for being installed in internal combustion engines, where it is for instance used for tensioning the control chains. For this purpose, the tensioning means 2 is directly or indirectly supported on the transmission element and has a filling body 3 as well as a tensioning piston 4.

Furthermore, the tensioner 1 comprises a housing 5 in which the filling body 3 and the tensioning piston 4 are accommodated.

The housing 5 forms a pressure chamber 6 together with the tensioning piston 4. The pressure chamber 6 is pressurised by a tensioning pressure which presses the tensioning piston and the tensioning sleeve in the direction of the arrow S away from the housing 5. Moreover, a spring 7 is arranged in the pressure chamber 6, through which the tensioning means 2, 3, 4 is also pressed in the direction of arrow P away from the housing.

The pressure chamber 6 is connected to a chamber 9 via a supply line 8, in which said chamber a valve 10 is arranged. In the embodiment of FIG. 1 the valve 10 is formed as a return valve which is transferred into a closing position by the tensioning pressure, which acts in the pressure chamber 6, the supply line 8 and the chamber 9. In this closing position the pressure connection between the pressure chamber 6 and a supply connection 11 is interrupted. The supply connection 11 is pressurised by a supply pressure, which is supplied to the pressure chamber 6 when the valve 10 is open.

The valve 12 comprises a closing body 12—in the embodiment of FIG. 1 it is formed as a sphere. The sphere is accommodated in a guiding cage 13 which is attached in a tensioning part 14. The tensioning part 14 forms an integral valve unit in the form of a block, which can be attached with the pre-mounted valve 10 on the housing 5 through attachment means that are not shown. The chamber 9 partially extends in the housing 5 and partially in block 14. As an alternative, the chamber 9 may also be formed in the housing 5 only or in the block 14 only. The chamber 9 is also formed such that the pre-mounted valve 10 can be inserted with the guiding cage 13.

An aperture 15 is formed in the housing 5 in parallel to the connection line 8, said aperture also forming a connection between the supply connection 11 or the chamber 9 and the pressure chamber 6. The aperture is arranged coaxially with respect to the tensioning piston 4, the filling body 3 and the supply connection 11. As an alternative, the aperture may, however, also have other designs.

An operating element 16 longitudinally movable in the housing 5 is accommodated in the aperture 15. As shown in FIG. 1, the operating element 16 may be formed as a substantially cylindrical piston, whose one end 17 comprises a pressure receiving surface, which adjoins the pressure chamber, and whose other end reaches up to the closing body 12. The operating element 16 is preferably designed in a manner that the aperture 15 is sealed.

A chamber 19 may be formed between the operating element 16 and the housing 5, said chamber being connected to the environment of the tensioner 1 via a line 20.

The pretensioning element 21 causes a pretensioning force to act on the operating element, which presses the operating element 16 away from the closing body 12 into the open position. According to FIG. 1, the pretensioning element 21 may be formed as a helical pressure spring, which is supported between a housing-sided section and the operating element.

The pretensioning element 21 may, as shown in FIG. 1, be arranged in the chamber 9 and may coaxially overlap the operating element 16.

The pretensioning element 21 may, however, also be arranged at different positions, e.g. in the chamber 19. As an alternative, the chamber 19 as a pressure chamber may form a hydraulic pretensioning element, which presses the operating element 16 in FIG. 1 towards the left.

Finally, the tensioning means 1 has a leakage means 22, which serves for ventilating the cylinder and which may be formed as a bore in the tensioning piston 4, as shown in FIG. 1. The bore 22 has such a small diameter that its flow resistance is very large and that only few pressure fluid may emerge from the pressure chamber. The pressure chamber 6 is connected to the environment of the tensioner 1 through the leakage means 22, so that the tensioning pressure gradually decreases due to the high flow resistance caused by leakage. Moreover, a leakage is generated at the leakage gap between the piston and the cylinder. The leakage gap also serves for ventilating the cylinder or the pressure chamber 6.

The function of the tensioner will now be described more precisely.

The tensioning force F acting during operation of the tensioner 1 onto the endless transmission element is composed of the force of the pressure spring 7 and the force of the tensioning pressure acting in the pressure chamber 6. The force generated by the tensioning pressure results from the supply pressure P and the cross-sectional surface of the tensioning means 2 in the direction transversely to the tensioning force F.

In the embodiment of FIG. 1 the supply of the pressure fluid, preferably pressure oil, from the supply connection 11 to the pressure chamber 6 is regulated at the valve 10 via the operating element: as soon as the tensioning pressure generates a force through the pressure receiving surface 17, which is larger than the counteracting pretensioning force of the pretensioning element 21, the operating element 16 moves in the aperture 15 in the direction of the closing body 12. The closing body 12 is pressed in the direction of the valve seat and the valve 10 is transferred into the closing position, as it is shown in FIG. 1. In the closing position, the connection between the supply connection 11 and the pressure chamber 6 is interrupted.

Due to the adjustment of the pretensioning force generated by the pretensioning element 21, the tensioning pressure is defined as of which the valve 10 is transferred into the closing position by the operating element 16.

Caused by leakage of the pressure fluid through the leakage means 22, the tensioning pressure in the pressure chamber 6 decreases so that the force acting in the closing direction on the pressure receiving surface 17 becomes smaller. When falling below a predetermined tensioning pressure, the valve 10 opens under the influence of the pretensioning element 31. The valve 10 is transferred from the closing position into the open position until the tensioning pressure has increased to such an extent that the valve 10 closes again.

Moreover, the valve 10 opens when the chain tension decreases, if the tensioning means 2 is pressed out of the housing by the pressure spring 7 so that the volume of the pressure chamber 6 increases and the pressure in the pressure chamber 6 drops.

If the operating element 16 is in its rest position, into which it is pressed by the pretensioning element 21, the closing body 12 may move into the open and/or closing position independent of the operating element 16. The movements of operating element 16 and closing body 12 are only coupled with one another if the closing body 12 is pressed into the closing position by the operating element 16. Otherwise, the closing body 12 and the operating element 16 are accommodated in the tensioner in a manner movable independent of each other.

Consequently, the valve 10 together with the operating element 16 and the pretensioning element 21 forms a tensioning pressure control valve, which opens or closes depending on the level of the tensioning pressure.

When moving the operating element 16 into the closing position, air is pressed from the chamber 19 through the supply line 20 towards the outside. Due to the tight flow cross section of the line 20, the movement of the operating element 16 is attenuated by the air escaping from the chamber 19 only slowly.

The operating element 16, the pretensioning element 21 and the closing body 12 together form a closing unit, which—as an attenuator—also includes the chamber 19 and the line 20.

If the supply pressure P ceases to exist, the pretensioning element 21 holds the valve 10 in the open position so that the pressure chamber is immediately filled with oil when starting the internal combustion engine.

1. A tensioner (1) for endless transmission elements, such as chains or belts, comprising a pressure chamber (6) that is pressurized by a tensioning pressure to actuate tensioning means (2, 3, 4) acting upon the transmission element, a supply connection (I1) that is pressurized by a supply pressure (P), a valve (10) interposed between the pressure chamber (6) and the supply connection (1), the valve including a closing unit (12, 13, 21, 16, 17, 10) that can be transferred to a closed position by the tensioning pressure, the valve (10) being designed as a tensioning pressure control valve in that the closing unit (12, 13, 21, 16, 17, 10) is provided with a substantially spring-elastic pretensioning element (21) that counteracts the transfer to the closed position.

2. A tensioner (1) as claimed in claim 1, wherein the closing unit (12, 13, 21, 16, 17, 10) comprises a closing body (12) through which in the closed position a connection between the supply connection (11) and the pressure chamber (6) is locked in a pressure-tight manner.

3. A tensioner (1) as claimed in claim 2, wherein the closing body (12) is formed substantially spherically.

4. A tensioner (1) as claimed in claim 2, wherein the closing unit (12, 13, 21, 16, 17, 10) comprises an operating element (16) through which the closing body (12) is pressed into the closed position when exceeding a predetermined tensioning pressure.

5. A tensioner (1) as claimed in claim 2, wherein the pretensioning element (21) is supported between a housing-sided section of the tensioner (1) and the operating element (16).

6. A tensioner (1) as claimed in claim 4, wherein the operating element (16) and the closing body (12) are accommodated in the tensioner (1) in a manner substantially movably independent of each other.

7. A tensioner (1) as claimed in claim 4, wherein the operating element (16) comprises a pressure receiving surface (17) adjoining the pressure chamber (6).

8. A tensioner (1) as claimed in claim 7, wherein an end (18) of the operating element (16) opposing the pressure receiving surface (17) reaches up to the closing body (12).

9. A tensioner (1) as claimed in claim 4, wherein the operating element (16) is formed as a piston longitudinally movable substantially in the tensioning direction (S) of the tensioner (1).

10. A tensioner (1) as claimed in claim 1, wherein the valve (10) is formed as a return valve.

11. A tensioner (1) as claimed in claim 4, wherein the pretensioning element (21) is formed as a pressure spring.

12. A tensioner (1) as claimed in claim 11, wherein the pressure spring (21) and the operating element (16) are at least sectionally arranged in a coaxially overlapping manner.

13. A tensioner (1) as claimed in claim 1, and a leakage means (22) is provided through which the tensioning pressure in the pressure chamber can be reduced.

14. A tensioner (1) as claimed in claim 13, wherein the leakage means (22) has a leakage line which leads from the pressure chamber to the environment of the tensioner.
